(19) United States
(12) Patent Application Publication
(10) Pub. No.: US 2014/0039993 A1
(43) Pub. Date: Feb. 6, 2014

(54) GAME SERVER DEVICE, MANAGEMENT METHOD AND TICKET ISSUING SYSTEM

(71) Applicant: Takamitsu Kinjo, Minato-ku (JP)

(72) Inventor: Takamitsu Kinjo, Minato-ku (JP)

(73) Assignee: KONAMI DIGITAL ENTERTAINMENT CO., LTD., Minato-ku, Tokyo (JP)

(21) Appl. No.: 14/110,761

(22) PCT Filed: Apr. 11, 2012
(86) PCT No.: PCT/JP2012/059891

§ 371 Date: Oct. 9, 2013

(30) Foreign Application Priority Data
Jun. 22, 2011 (JP) 2011-138117

(51) Int. Cl. G06Q 30/02

(52) U.S. Cl. CPC G06Q 30/0209
USPC 705/14.12

(57) ABSTRACT

A game server device used in a ticket issuing system for issuing identification information or a ticket based on the identification information and connected, via a network, to a portable terminal for providing a user with a game in which an item is acquired. The game server device generates identification information in accordance with a seed value assigned to a predetermined specific item, and transmits, in association with the specific item, the identification information generated in accordance with the seed value of the specific item to the terminal of the user who has acquired the specific item.

### TECHNICAL FIELD

The present invention relates to technology for game systems and the like provided on general websites and SNS sites (Social Networking Service sites).

### BACKGROUND ART

In recent years, games have become popular that proceed while web pages are displayed on a portable terminal using the Internet. In such a game, a game program is not executed on the portable terminal, and instead, a game server device generates a web page according to an input operation of the portable terminal, and this web page is displayed on the portable terminal (Non-Patent Document 1).

### CITATION LIST

### Non-Patent Document

### Non-Patent Document 1

“Social Game General Information Magazine Appli-Style Vol. 2”, published by East Press, Apr. 1, 2011, pp. 26-29.

### SUMMARY OF INVENTION

### Problems to be Solved by the Invention

However, even if a certain event occurs in the execution process of a game, it is only one of the events in the game.

The present invention was developed in view of the above situation, and an object thereof is to provide a technology in which a player who has acquired a virtual item in a game is able to sense a new game feeling in the real world, by the provision of some sort of value.

### Solution to Problem

The present invention is directed to a game server device used in a ticket issuing system for issuing a ticket in correspondence with identification information or information based on the identification information, the game server device being connected, via a network, with a terminal for providing a user with a game in which an item is acquired, having: a first identification information generator that generates identification information in accordance with a seed value assigned to a predetermined specific item; and an identification information transmitter that transmits, in association with the specific item, the identification information generated in accordance with the seed value of the specific item to a terminal of a user who has acquired the specific item.

In a preferred mode of the present invention, the first identification information generator is preferably a pseudorandom number generator that successively generates unique identification information for the assigned seed value.

Furthermore, in a preferred mode of the present invention, the pseudorandom number generator preferably generates as many pieces of the identification information as a set issuance number.

The present invention is also directed to a ticket issuing system, having the above game server device and a shop device, in which the shop device has a second identification information generator that generates identification information by the same algorithm as an algorithm used by the first identification information generator, a determiner that determines whether or not identification information presented from the terminal is identification information generated by the second identification information generator, and a ticket issuing unit that issues a ticket corresponding to the presented identification information in a case in which a determination result by the determiner is affirmative.

In a preferred mode of the present invention, the same seed value is preferably set for the specific item in the first and second identification information generators.

Furthermore, in a preferred mode of the present invention, the determiner preferably outputs an affirmative determination result in a case in which the identification information presented from the terminal is identification information generated by the second identification information generator and in which the ticket corresponding to the presented identification information has not been issued yet.

On the other hand, the present invention is directed to another ticket issuing system, comprising the above game server device and a shop device connected to the game server device via a network, in which the shop device includes a determiner that determines whether or not identification information presented from the terminal is identification information generated by the first identification information generator and is shared with the game server device, and a ticket issuing unit that issues a ticket corresponding to the presented identification information in a case in which a determination result by the determiner is affirmative.

Furthermore, in a preferred mode of the present invention, the determiner preferably outputs an affirmative determination result in a case in which the identification information presented from the terminal is shared identification information and in which the ticket corresponding to the presented identification information has not been issued yet.

The present invention is further directed to a management method used in a ticket issuing system for issuing a ticket in correspondence with identification information or information based on the identification information, the method being performed in a game server device connected, via a network, to a terminal for providing a user with a game in which an item is acquired, the method having: a step of generating identification information in accordance with a seed value assigned to a predetermined specific item; and a step of transmitting, in association with the specific item, the identification information generated in accordance with the seed value of the specific item to a terminal of a user who has acquired the specific item.

### BRIEF DESCRIPTION OF DRAWINGS

FIG. 1 is a block diagram of a ticket issuing system according to a first embodiment of the present invention.

FIG. 2 is a block diagram showing a configuration of a game server device.

FIG. 3 is a block diagram showing a configuration of a center server device.

FIG. 4 is a diagram showing a sequence until identification information is assigned to a communication terminal.

FIG. 5 is a table showing an example of contents of a database in the game server device.

FIG. 6 is a chart showing an example of acquiring a specific item.

FIG. 7 is a diagram showing a display example on the communication terminal, to which identification information has been assigned,

FIG. 8 is a chart showing a sequence until a ticket is issued.

FIG. 9 is a table showing an example of contents of a database in the center server device.

FIG. 10 is a diagram showing an example of a ticket to be issued.

FIG. 11 is a block diagram of a ticket issuing system according to a second embodiment of the present invention.

FIG. 12 is a chart showing a sequence until a ticket is issued.

FIG. 13 is a table showing an example of contents of a database in a game server device.

### EMBODIMENTS OF INVENTION

### First Embodiment

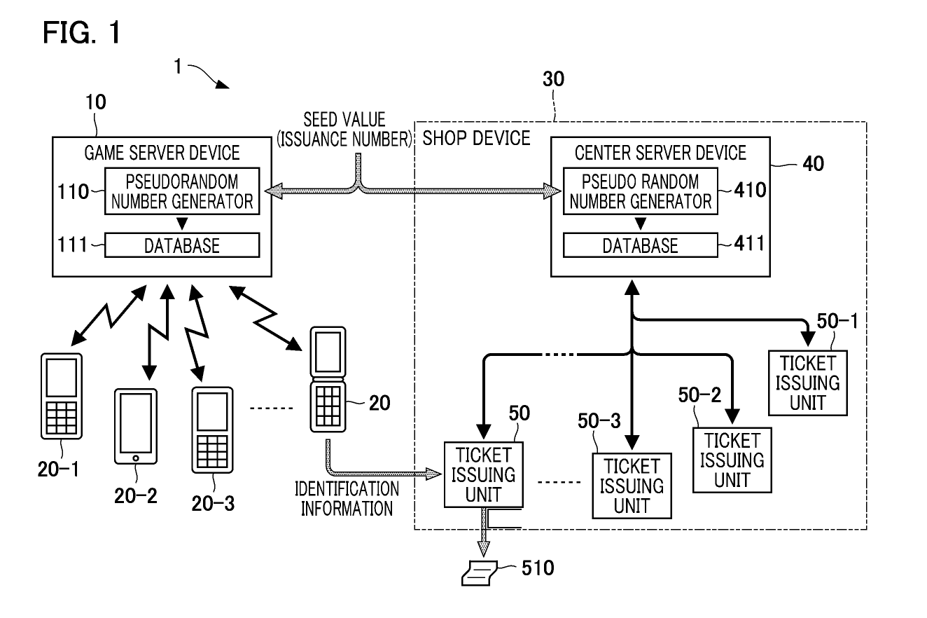

FIG. 1 is a block diagram showing the configuration of a ticket issuing system 1 according to a first embodiment of the present invention.

As shown in FIG. 1, the ticket issuing system 1 includes a game server device 10, portable terminals 20-1, 20-2, 20-3, etc., and a shop device 30. Out of these, the portable terminals 20-1, 20-2, 20-3, etc., are personal computers, mobile phones and the like in which a web browser (software) is installed and are connected to the game server device 10 via a network such as a mobile communication network.

It should be noted that the number of portable terminals connected to the game server device 10 may actually be one or may be more than one. Furthermore, the portable terminals are denoted by reference numeral 20 by omitting numerals after the hyphen for the sake of convenience in the following description.

In this embodiment, the game server device 10 has a function of generating a web page of a game screen corresponding to the operation of the portable terminal 20 or the like and transmitting it to the portable terminal. According to this function, when a user operates the portable terminal 20 connected to the game server device 10, a game screen corresponding to this operation is displayed on the portable terminal 20. At this time, the portable terminal 20 provides a game to the user by transmitting information corresponding to the operation or the like to the game server device 10 and receiving and displaying the web page from the game server device 10.

In this embodiment, identification information is assigned to the user when a specific item to be described later is acquired. For this assignment, the game server device 10 includes a pseudorandom number generator 110 and a database 111. The pseudorandom number generator 110 enables, for example, a first function and a second function to be called up. The first function is a function for initializing the pseudorandom number generator and determining a pseudorandom number sequence based on an argument in accordance with a predetermined algorithm when the function is called up. The second function is a function for obtaining pseudorandom numbers (pseudorandom number values) one by one from the leading end of the pseudorandom number sequence determined by the first function every time the second function is called up.

The pseudorandom number generator 110 calls up the first function using a seed value (initial value) assigned by an administrator as an argument and, thereafter, successively generates as many pseudorandom numbers as an issuance number using this seed value as the initial value by repeatedly calling up the second function. The database 111 manages identification information based on the generated pseudorandom numbers, particularly in this embodiment. Besides this, the database 111 manages identification codes unique to users for login and manages a game progress status in each portable terminal. It should be noted that game progression and the like are managed for each identification code of the user because the same user may log into the game server device 10 at different times using two or more portable terminals 20.

The shop device 30 includes a center server device 40, ticket issuing units 50-1, 50-2, 50-3, etc. The ticket issuing units 50-1, 50-2, 50-3, etc. are, for example, so-called multimedia terminals installed in a shop such as a convenience store and issue a ticket or the like in response to a touch operation on a display screen which doubles as an input unit, to information transfer in a non-contact manner, or the like. The ticket issuing units 50-1, 50-2, 50-3, etc., are respectively connected to the center server device 40 via a network such as an in-house dedicated line or a public line.

It should be noted that the ticket issuing units are denoted by reference numeral 50 by omitting numerals after the hyphen for the sake of convenience in the following description.

The center server device 40 includes a pseudorandom number generator 410 and a database 411. Out of these, the pseudorandom number generator 410 generates pseudorandom numbers in accordance with the same algorithm as the pseudorandom number generator 110 provided in the game server device 10. The database 411 manages identification information based on the pseudorandom numbers generated by the pseudorandom number generator 410, a ticket issuance status in each ticket issuing unit, and the like.

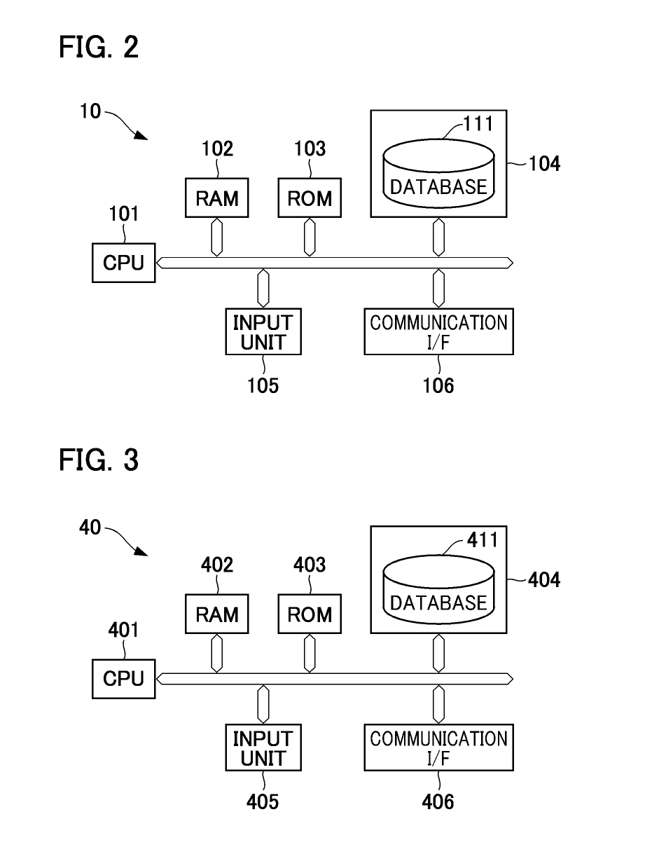

FIG. 2 is a block diagram showing a configuration of the game server device 10. As shown in FIG. 2, the game server device 10 includes a CPU (Central Processing Unit) 101 for controlling the entire device, a RAM (Random Access Memory) 102 functioning as a work area of the CPU 101, a ROM (Read Only Memory) 103 storing a boot program and the like, a hard disk 104 storing various programs and data, an input unit 105 including a keyboard, a mouse and the like, and a communication interface 106 for communicating with each portable terminal 20 via the network.

The hard disk 104 has stored therein the above database 111 in addition to the first and second functions that are called up when the CPU 101 functions as the pseudorandom number generator 110.

It should be noted that the game server device 10 may be configured by a plurality of servers. For example, the game server device 10 may be separated into a server for managing and executing a game with the portable terminals and a server for managing the assignment of the identification information to be described later and the like.

FIG. 3 is a block diagram showing a configuration of the center server device 40 in the shop device 30. As shown in FIG. 3, the center server device 40 includes a CPU 401, a RAM 402, a ROM 403, a hard disk 404, an input unit 405, and a communication interface 406, similarly to the game server device 10. The hard disk 404 has stored therein the above database 411 in addition to two functions that are called up when the CPU 401 functions as the pseudorandom number generator 410. It should be noted that the two functions that are called up when the CPU 401 functions as the pseudorandom number generator 410 are the same as the first and second functions that are called up when the CPU 101 functions as the pseudorandom number generator 110. Furthermore, the communication interface 406 is for communicating with each ticket issuing unit 50 via the network.

Next, the operation of the ticket issuing system 1 is described.

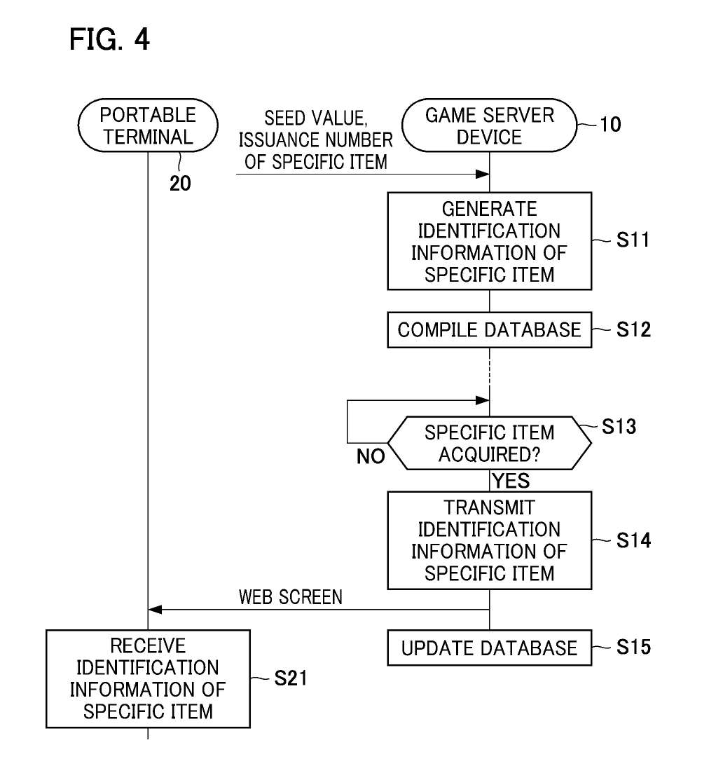

FIG. 4 is a chart showing an operation sequence since identification information is generated by the game server device 10 until the identification information is assigned to the user of the portable terminal 20 in the ticket generating system 1.

First, a seed value and an issuance number corresponding to a specific item are set for the pseudorandom number generator 110 as a premise to assign the identification information for ticket issuance.

Here, items are tools in general including tools obtained by a certain means or method by a character and the like operated by the user (player) of the portable terminal 20 and tools which provide a certain effect by being used in a game provided by the portable terminal 20. Furthermore, in this description, a specific item is a part of such a plurality of items or a part or all of items that are obtained by synthesizing the same type or different types of items, and is used to mean something that can provide a certain economic value beyond the bounds of games. One specific item may be provided or a plurality of specific items may be provided. If there are multiple specific items, a seed value is assigned to each specific item.

Furthermore, in some cases, the specific item appears during a limited time, e.g., only during a summer holiday.

In this embodiment, the pseudorandom number generator 110 successively generates the pseudorandom numbers in accordance with the set seed value as many as the set issuance number (S11). The game server device 10 registers the generated pseudorandom numbers as the identification information in the database 111 (S12). It should be noted that S11 and S12 are performed for each specific item if there are multiple specific items.

In a state in which the identification information corresponding to the specific item is registered in the database 111, the game server device 10 determines whether or not any of the logged-in users has acquired the specific item (S13). If none of the users has acquired the specific item, the game server device 10 does not perform any special process other than processes relating to the game.

On the other hand, in a case in which it is determined that one of the users has acquired the specific item, the game server device 10 refers to the database 111 and searches an identification information piece that has not yet been assigned to the users out of the registered identification information pieces. Then, the game server device 10 generates a web screen on which the searched identification information is associated with this specific item and transmits it to the portable terminal 20 of the user who has acquired this specific item (S14). Thereafter, the game server device 10 updates the database 111 (S15) to record that this identification information is already transmitted.

On the other hand, the portable terminal 20 of the user who has acquired the specific item receives the web screen including the identification information of this specific item from the game server device 10 (S21).

The operation up to this point is more specifically described.

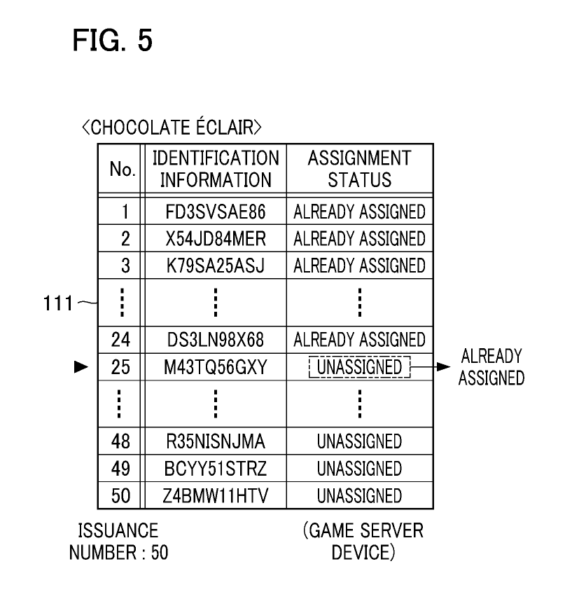

FIG. 5 is a table showing an example of the database 111. In this example, the identification information is shown in a case in which the specific item is, for example, a “chocolate éclair” and in which the issuance number is set at “50”. In this embodiment, the identification information is composed of ten alphanumeric characters and successively generated uniquely for each of the number (No.) of “1” to “50” corresponding to the issuance number. It should be noted that the identification information may be merely sequences composed of alphanumeric characters or may be obtained by encoding these sequences.

Pieces of identification information are formatted into a table with a flag added to each piece of identification information, the flag indicating whether or not the identification information has been already assigned to the user. It should be noted that the default of this flag is a value indicating that the identification information has not been assigned yet. Thus, in the example shown in FIG. 5, it is indicated that, out of the identification information allotted to each of the numbers “1” to “50”, the identification information pieces of the numbers “1” to “24” are already assigned.

It should be noted that the table as shown in FIG. 5 is generated in the database 111 for each specific item if there are a plurality of specific items. Even in this case, the identification information is unique.

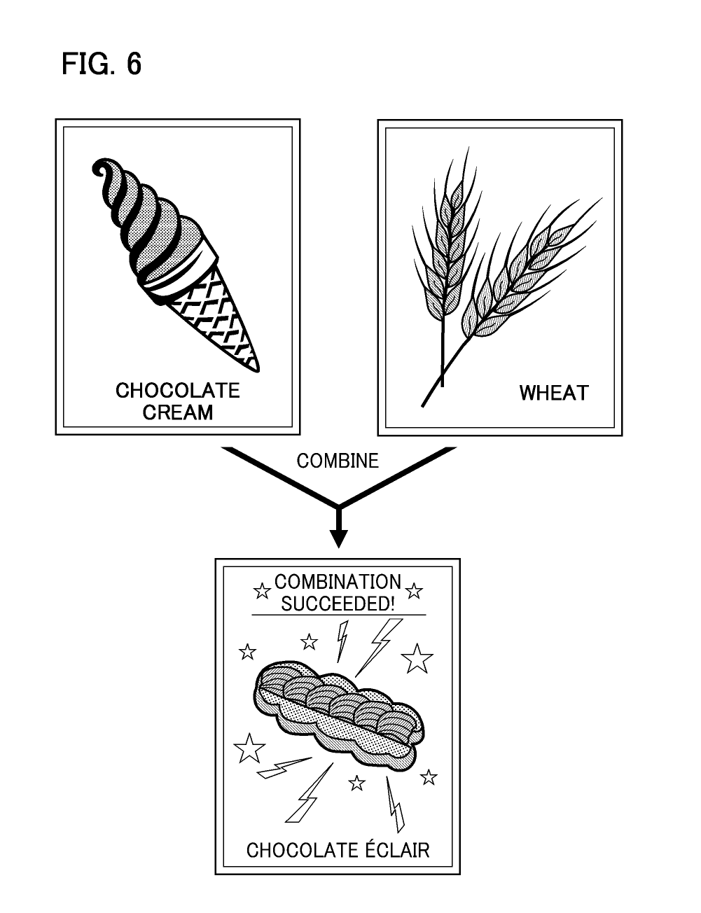

FIG. 6 is a diagram showing an example of a case in which a specific item is generated by synthesizing two different types of items. In FIG. 6, the user is in a state where the user has already acquired an item “chocolate cream” and an item “wheat”. When an instruction is given to synthesize the two items in this state, this instruction is transmitted to the game server device 10. The game server device 10 synthesizes a new item “chocolate éclair” from the items “chocolate cream” and “wheat”, transmits it to the portable terminal 20 of this user, and deletes the items “chocolate cream” and “wheat” used as bases of the synthesis from this user's items.

In this way, this user acquires the new item “chocolate éclair” and, on the other hand, loses the items used as the bases of the synthesis. It should be noted that, instead of deleting the items as the bases of the synthesis, either one or both may be left depending on a condition.

Here, if the synthesized item is a specific item, the game server device 10 refers to the database 111 and searches the identification information corresponding to the smallest number out of the pieces of the identification information for which the flag indicates an unassigned state in a table corresponding to the specific item “chocolate éclair”. In the example shown in FIG. 5, the pieces of the identification information for which the number is “1” to “24” have already been assigned. Thus, the game server device 10 searches the identification information “M43TQ56GXY” whose number is “25”. Thereafter, the game server device 10 generates a web screen for associating the searched identification information “M43TQ56GXY” with the “chocolate éclair” and transmits it to the portable terminal 20 of the user who has acquired the “chocolate éclair”.

Thereafter, the game server device 10 changes the flag of the number “25” from an unassigned state to an already assigned state as shown in FIG. 5. In this way, it is recorded that the identification information corresponding to this number “25” is already transmitted.

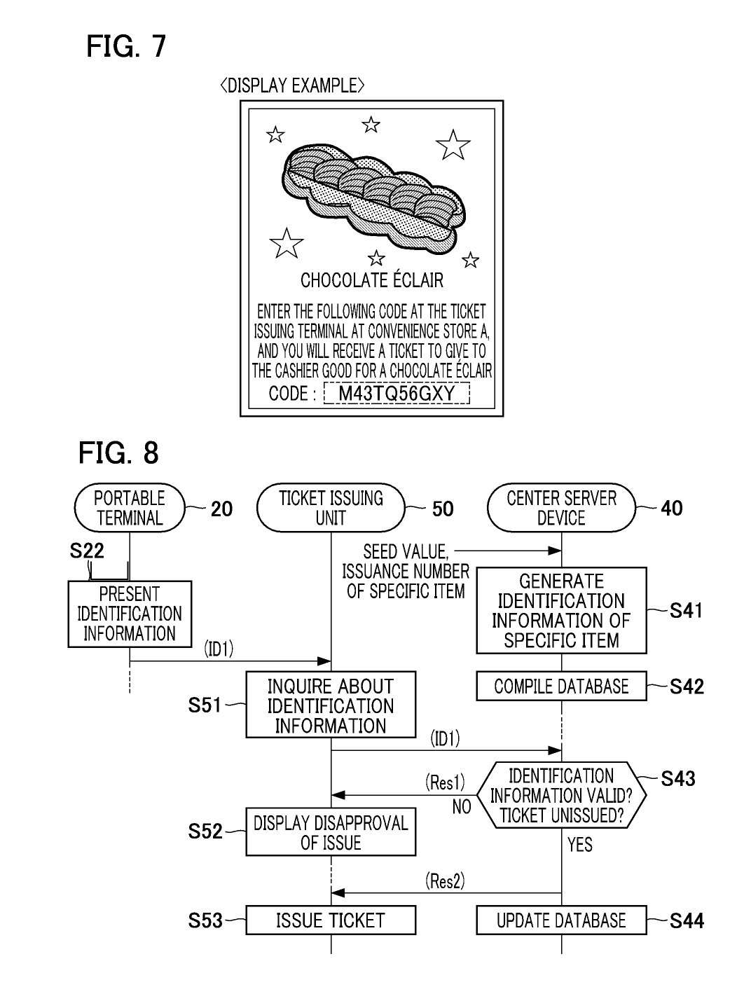

FIG. 7 is a diagram showing an example of the web screen transmitted from the game server device 10 to the portable terminal 20 of the user who has acquired the specific item “chocolate éclair”. As shown in FIG. 7, the identification information “M43TQ56GXY” and a message are shown in association with the “chocolate éclair”. Thus, the user of this portable terminal 20, i.e., the user who has synthesized the two items, comes to know what to do next.

It should be noted that in a case in which another user acquires the specific item “chocolate éclair”, a web screen associating the identification information (not shown) of the next number “26” to the “chocolate éclair” is generated and transmitted to the portable terminal of this other user. Therefore, the same identification information is not transmitted to two or more different users.

Furthermore, in a case in which a user acquires the specific item “chocolate éclair” anew and if all the flags of the identification information indicate that the identification information is already assigned in the table corresponding to the “chocolate éclair” of the database 111, it means that the pieces of identification information corresponding to the planned issuance number “50” have already been transmitted to other users. Thus, the game server device 10 transmits a message to that effect to the portable terminal of the user who acquired the “chocolate éclair” anew.

However, concerning only the acquisition and synthesis of items, they are normal actions in games. The fact that the acquisition of a specific item would provide a certain economic value as in this embodiment could be first known to a user when a web screen (see FIG. 7) associated with the specific item is displayed. Conversely, even if a specific item is acquired, the game is seemingly no different from normal games unless a web screen as shown in FIG. 7 is displayed.

Thus, when a user acquires a specific item, the game server device 10 may not have to transmit any information to the portable terminal of this user even if the identification information corresponding to the specific item has already been transmitted for as many numbers as the issuance number.

FIG. 8 is a chart showing a sequence of the operation until a ticket is issued in the ticket issuing system 1. The ticket mentioned here means, for example, the one having a certain economic value such as an exchange ticket for a commodity, a coupon or a service ticket. Furthermore, the mode of issuance includes a mode of storing in an IC card, a portable terminal or the like in addition to a mode of printing on a paper medium or the like.

First, the same seed value and issuance number as those set in the pseudorandom number generator 110 are set in the pseudorandom number generator 410 in the center server device 40. The pseudorandom number generator 410 generates pseudorandom numbers in accordance with the set seed value as many as the set issuance number (S41). The game server device 10 stores the generated pseudorandom numbers as identification information in the database 411 (S42). It should be noted that S41 and S42 are performed for each specific item if there are a plurality of specific items.

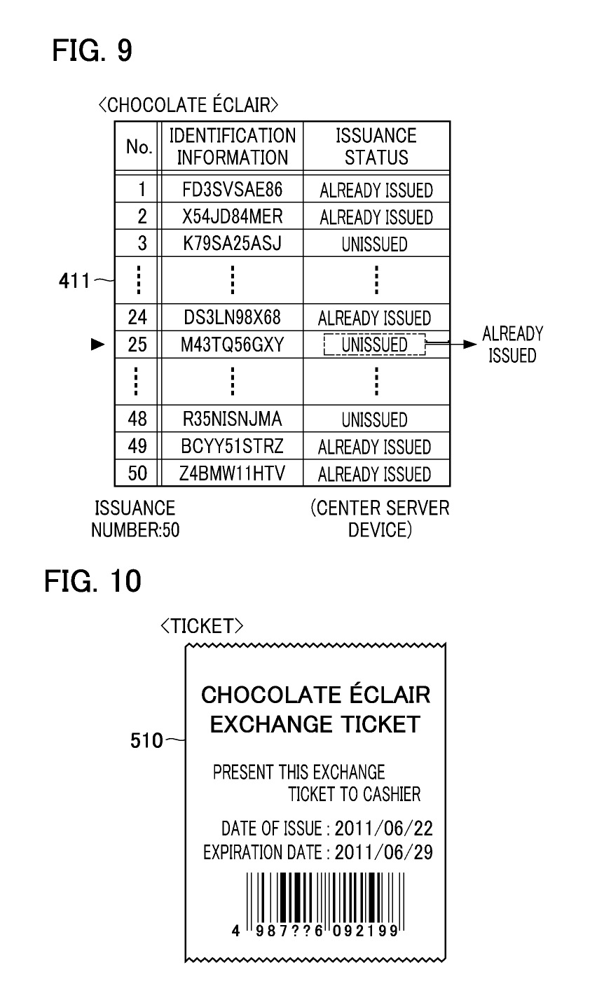

FIG. 9 is a table showing an example of the database 411.

The pseudorandom number generator 410 has the same algorithm as the pseudorandom number generator 110 and the same seed value and the same issuance number are set for the specific item in this embodiment. Thus, in FIG. 9, a relationship between the number (No.) corresponding to the issuance number and the identification information to be generated will be the same as in the database 111 shown in FIG. 5, for example, for the specific item “chocolate éclair”.

Furthermore, in this database 111, pieces of identification information are formatted into a table with a flag added to each piece of identification information, the flag indicating whether or not a ticket has been already issued for the identification information. The default of this flag is a value indicating that the ticket has not been issued yet.

It should be noted that the ticket is issued when a user who has acquired a specific item goes to the shop and operates the ticket issuing unit 50 as described next. Since this operation is performed at the user's discretion, the flag indicating the ticket issuance status for the identification information is not related to a chronological order at all as in the example shown in FIG. 9.

Referring back to FIG. 8, the identification information (ID1) is presented from the portable terminal 20 having received the web screen including the identification information of the specific item from the game server device 10 to the ticket issuing unit 50 installed in any of the shops (S22).

The presentation of the identification information mentioned here means an action necessary and sufficient for the ticket issuing unit 50 to obtain the identification information from the portable terminal 20 such as:

(A) the user of the portable terminal 20 holds the identification information displayed on this portable terminal 20 or encoded information of the identification information over a reader of the ticket issuing unit 50;
(B) the identification information is transmitted to the ticket issuing unit 50 via short-distance (infrared or wireless) communication established between the portable terminal 20 and the ticket issuing unit 50; and
(C) the user of the portable terminal 20 inputs the identification information by operating an input unit of the ticket issuing unit 50.

At this time, the identification information may be such that a redundant code such as a parity is added to the sequence of ten alphanumeric characters described above.

The ticket issuing unit 50 inquires the center server device 40 about the identification information (ID1) presented from the user (S51). The center server device 40 refers to the database 411 and determines whether or not to issue a ticket corresponding to the identification information (ID1) (S43). Specifically, this determination is made as follows. That is, the center server device 40 refers to the database 411 and firstly determines whether or not the inquired identification information (ID1) is registered in the database 411 and secondly determines whether or not the flag corresponding to this identification information indicates that the ticket has not been issued yet if the identification information is registered (S43).

In a case in which the first determination result is negative, i.e., in a case in which the inquired identification information (ID1) is not registered in the database 411, there is a high probability that that identification information is erroneously input. Furthermore, if the second determination result is negative, it indicates that the ticket corresponding to the inquired identification information (ID1) has been already issued.

Accordingly, the center server device 40 transmits an issue prohibition notification (Res1) to the ticket issuing unit 50, to which the identification information (ID1) was presented if at least either one of the first and second determination results are negative. The ticket issuing unit 50 having received the issue prohibition notification (Res1) makes a display to the effect that the ticket corresponding to this identification information cannot be issued (S52).

In a case in which both the first and second determination results are affirmative, an issue permission notification (Res2) is transmitted to the ticket issuing unit 50, to which the identification information (ID1) was presented. Thereafter, the center server device 40 updates the database 411 to record that the ticket corresponding to this identification information is already issued (S44).

For example, the center server device 40 updates the flag of the number “25” from an unissued state to an already issued state as shown in FIG. 9 in a case in which the issuance of the ticket corresponding to the identification information “M43TQ56GXY” whose number is “25” is permitted. Accordingly, even if the identification information “M43TQ56GXY” is presented in any of the ticket issuing units 50 thereafter, the issuance of a ticket based on this identification information will not be permitted.

On the other hand, the ticket issuing unit 50 having received the issue permission notification (Res2) actually issues the ticket corresponding to this identification information (S53).

FIG. 10 is a diagram showing an example of a ticket 510 issued at this time. As shown in FIG. 10, the ticket 510 is printed, for example, on a paper medium such as thermal paper.

The user only has to present the issued ticket 510 at a cashier of the shop, in which the ticket issuing unit 50 is installed, in accordance with an instruction written on this ticket 510. At the cashier, a shop employee hands over an actual “chocolate éclair” after reading a bar code printed on the ticket 510 for sales and inventory management. This handover may be automatically done by a machine.

As just described, according to the first embodiment, when a portable terminal of a user acquires a virtual specific item in a game provided by the portable terminal, identification information generated in accordance with a seed value assigned to the specific item is returned to the terminal of this user. The user can obtain a ticket corresponding to the returned identification information or on information based on this identification information. Because a “chocolate éclair” having an economic value in the real world can be obtained by this ticket, the user can experience a new game feeling different from conventional ones.

Additionally, according to the first embodiment, the game server device 10 and the center server device 40 need not cooperate with each other after a seed value and an issuance number corresponding to a specific item are respectively set in the pseudorandom number generators 110, 410. Thus, the game server device 10 and the center server device 40 can be ensured to be independent to a certain extent, and the present system can be applied also when a business proprietor (administrator) of the game server device 10 and that of the shop device 30 including the center server device 40 differ. Furthermore, according to the first embodiment, because a user having acquired a specific item needs to go to the shop where the ticket issuing unit 50 is installed, an effect of attracting customers to this shop can be expected.

In the first embodiment, the pseudorandom number generators call up the first function using the seed value (initial value) assigned by the administrator as an argument and, thereafter, repeatedly calls up the second function, thereby successively generating as many pseudorandom numbers as the issuance number whose initial value is this seed value. Thus, a plurality of pieces of identification information in accordance with the seed value assigned to the specific item can be uniquely generated. Furthermore, according to the above mode, ticket issuance can be restricted because the identification information is generated with the set issuance number as an upper limit.

Furthermore, in the first embodiment, the ticket issuing unit inquires the center server device about the identification information (ID1) presented from the user. The center server device refers to the database and firstly determines whether or not the inquired identification information (ID1) is registered in the database and secondly determines whether or not the flag corresponding to this identification information indicates that the ticket has not been issued yet if the identification information is registered. If both the first and second determination results are affirmative, the center server device transmits an issue permission notification to the ticket issuing unit, to which the identification information (ID1) was presented, and updates the database to record that the ticket corresponding to this identification information is already issued. Therefore, according to the first embodiment, two tickets issued using the same identification information can be prevented.

It should be noted that although the identification information pieces are formatted into the table together with the flags indicating the ticket issuance status in the first embodiment in the database 411, a list of identification information pieces for which a ticket can be issued may be generated at an early stage, and the identification information, for which the issuance of a ticket is permitted, may be deleted from this list. According to this configuration, identification information which is valid and for which no ticket has been issued yet is included in this list whereas identification information which is invalid or for which a ticket has been already issued is not included in this list. Therefore, a determination corresponding to S43 described above is possible.

### Second Embodiment

Next, a second embodiment of the present invention is described.

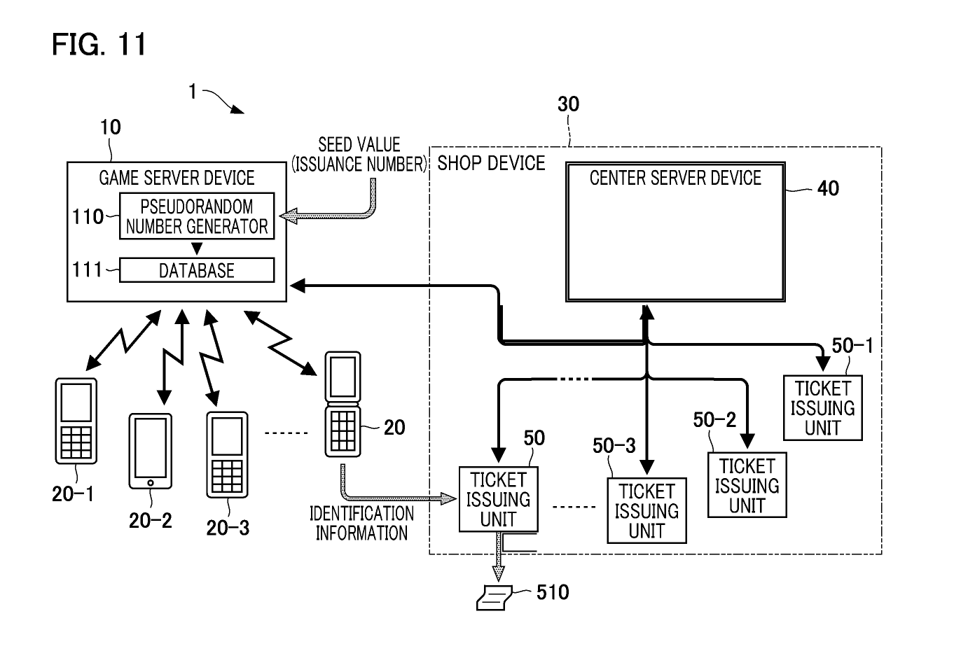

FIG. 11 is a block diagram showing the configuration of a ticket issuing system according to the second embodiment. The second embodiment shown in FIG. 11 differs from the first embodiment in that a game server device 10 and a center server device 40 are connected to each other via a network. In the second embodiment, a database 111 in the game server device 10 is shared with the center server device 40.

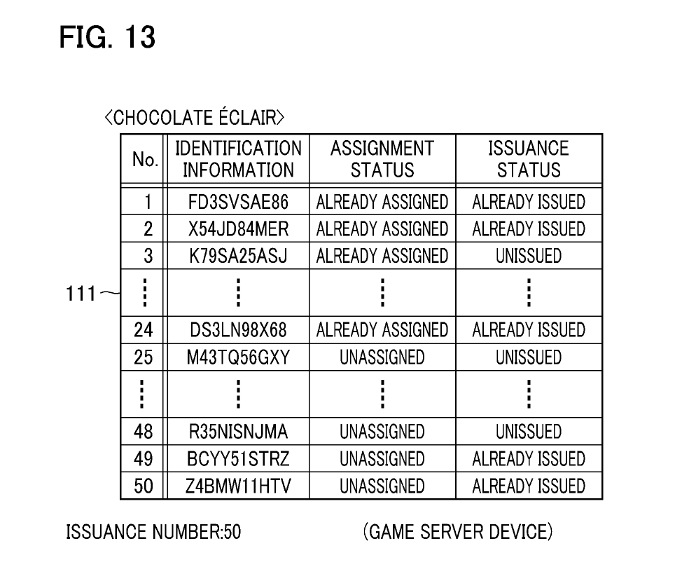

The database 111 in the second embodiment is a table as a combination of the tables shown in FIGS. 5 and 9 in the first embodiment, specifically, a table of generated identification information together with a flag indicating an assignment status and a flag indicating a ticket issuance status as shown in FIG. 13.

Since the database 111 is shared with the center server device 40 in the second embodiment, the center server device 40 includes neither the pseudorandom number generator 410 nor the database 411.

In the second embodiment, an operation sequence since the game server device 10 generates identification information until the identification information is assigned to a user of a portable terminal 20 who has acquired a specific item is the same as in the first embodiment.

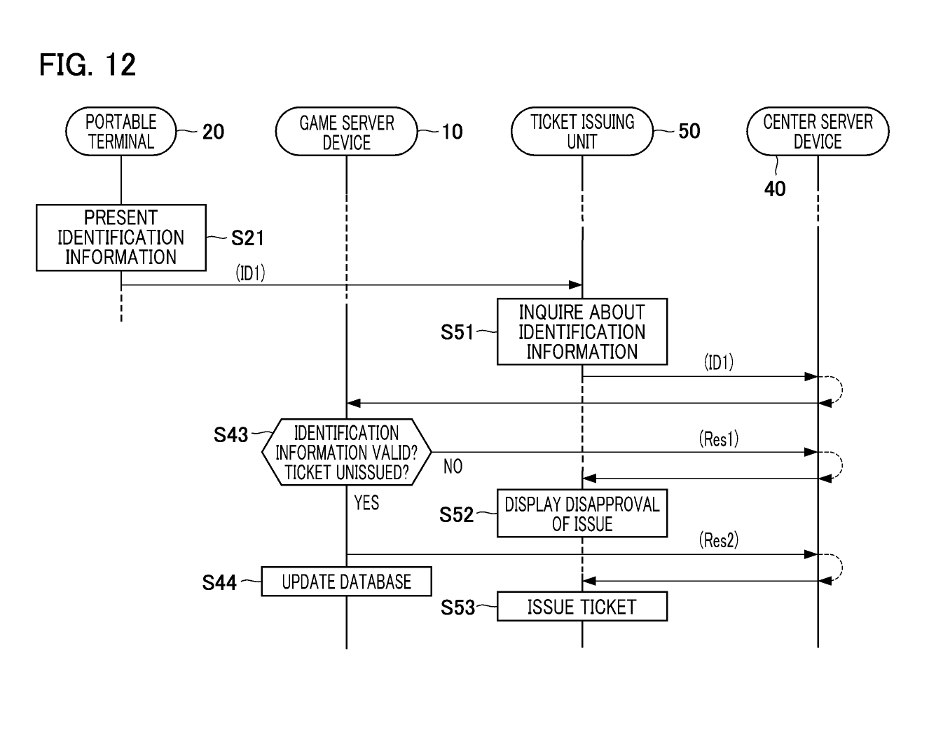

Furthermore, in the second embodiment, an operation sequence until a ticket is issued is also roughly the same as in the first embodiment as shown in FIG. 12. However, the center server device 40 does not include the database 411. Thus, the determination in S43 and the database updating in Step S44 shown in FIG. 8 are respectively performed by the game server device 10 as shown in FIG. 12.

It should be noted that since the center server device 40 does not include the database 411 managing the identification information in the second embodiment, the center server device 40 only transfers identification information (ID1) inquired from a ticket issuing unit 50 to the game server device 10 and transfers an issue prohibition notification (Res1) or an issue permission notification (Res2) from the game server device 10 to the ticket issuing unit 50.

As just described, in the second embodiment, when a portable terminal of a certain user acquires a specific item in a game provided by the portable terminal, identification information generated in accordance with a seed value assigned to the specific item is returned to the terminal of this user. The user can obtain a ticket corresponding to the returned identification information or information based on this identification information. Thus, the user can experience a new game feeling different from conventional ones.

Furthermore, according to the second embodiment, the game server device 10 and the center server device 40 are connected to each other via the network, and the database in the game server device can be shared between the game server device and the center server device. Thus, it is not necessary to provide the center server device 40 with the pseudorandom number generator 410 and the database 411 used to manage the identification information. Accordingly, the configuration of a shop device can be simplified. The center server device 40 only has to transfer identification information (ID1) inquired from the ticket issuing unit 50 to the game server device 10 and transfer an issue prohibition notification (Res1) or an issue permission notification (Res2) from the game server device 10 to the ticket issuing unit 50, and a processing load of the center server device 40 can be reduced.

Furthermore, in the second embodiment, when the ticket issuing unit inquires the center server device about the identification information (ID1) presented from the user, the center server device transfers the identification information (ID1) inquired from the ticket issuing unit 50 to the game server device 10, and the game server device refers to the database and firstly determines whether or not the inquired identification information (ID1) is registered in the database and secondly determines whether or not the flag corresponding to this identification information indicates that a ticket has not been issued yet if the identification information is registered. If both the first and second determination results are affirmative, the game server device transmits an issue permission notification to the ticket issuing unit, to which the identification information (ID1) was presented, via the center server device and updates the database to record that the ticket corresponding to this identification information is already issued. Therefore, also according to the second embodiment, two tickets issued using the same identification information can be prevented.

It should be noted that, in the second embodiment, every time a specific item is acquired by a user, identification information corresponding to that specific item may be successively generated by the game server device 10. Furthermore, the successively generated identification information pieces may be listed, and the ticket issuance status may be managed in correspondence with the listed pieces of identification information.

In the second embodiment, the center server device 40 may include the pseudorandom number generator 410 as in the first embodiment, and a seed value and an issuance number may be notified to this pseudorandom number generator 410 from the game server device 10, so that the database 411 may be assembled in the center server device 40.

Furthermore, the identification information of the specific item generated in the game server device 10 may be transferred to the center server device 40 via the network.

### Application and Modification

It should be noted that the present invention is not limited to the respective embodiments described above and that various applications and modifications are possible, for example, as described next. Furthermore, one or more of freely selected ones of modes of the following applications and modifications can also be appropriately combined.

For example, in each embodiment, the game is provided in a game browser type in which, when a user operates the portable terminal 20, the game server device 10 generates a web page of a game screen corresponding to the operation and transmits it to the portable terminal 20 so that this portable terminal 20 displays it. In the present invention, without being limited to this game browser type, a game may be provided in a native application type in which a program for executing the game is downloaded from the game server device 10, so that the portable terminal 20 executes this program.

In the embodiments, the number of the pieces of identification information generated by the game server device 10 and the number of tickets issued by the shop device 30 are matched. However, in practice, it is quite unlikely that all the users (players) who obtained the identification information of the specific item go to the shop, have a ticket issued and redeem the ticket for a commodity or the like.

Accordingly, the number of tickets issuable by the shop device 30 may be made less than the number of the pieces of identification information generated by the game server device 10.

Furthermore, although the identification information corresponding to the specific item is restricted to the set issuance number in the embodiments, this restriction may be lifted. Instead, unique identification information may be transmitted to the portable terminal having acquired the specific item, whereas the number of tickets issued upon the presentation of the identification information may be restricted to a certain number, e.g. “100”. If the number of tickets to be issued is restricted instead of restricting the number of the identification information to be transmitted, it is possible to add a new game element of issuing tickets not in the order of users who acquired the specific item, but in the order of users who presented the identification information to the ticket issuing unit 50.

Although the ticket has been described as an exchange ticket to be redeemed for an actual commodity in the embodiments, it only has to have a certain economic value, for example, such as a coupon, a complimentary ticket or a service ticket.

Furthermore, besides being printed on a paper medium as shown in FIG. 10, the ticket may be issued by being stored in an electronic storage medium such as an IC card or an internal memory of the portable terminal 20. In the case of storage in an electronic storage medium, this electronic storage medium only has to be read by a reader connected to the cashier of the shop.

### LIST OF REFERENCE SIGNS

1 . . . ticket issuing system, 10 . . . game server device, 20 . . . portable terminal, 30 . . . shop device, 40 . . . center server device, 50 . . . ticket issuing unit, 101, 401 . . . CPU, 110, 410 . . . pseudorandom number generator, 111,411 . . . database, 510 . . . ticket

1. A game server device used in a ticket issuing system for issuing a ticket in correspondence with identification information or information based on the identification information, the game server device being connected, via a network, with a terminal for providing a user with a game in which an item is acquired, comprising:
a first identification information generator that generates identification information in accordance with a seed value assigned to a predetermined specific item; and
an identification information transmitter that transmits, in association with the specific item, the identification information generated in accordance with the seed value of the specific item to a terminal of a user who has acquired the specific item.

2. The game server device according to claim 1, wherein the first identification information generator is a pseudorandom number generator that successively generates unique identification information for the assigned seed value.

3. The game server device according to claim 2, wherein the pseudorandom number generator generates as many pieces of the identification information as a set issuance number.

4. A ticket issuing system comprising:
the game server device according to claim 1; and
a shop device,
the shop device comprising:
a second identification information generator that generates identification information by the same algorithm as an algorithm used by the first identification information generator;
a determiner that determines whether or not identification information presented from the terminal is identification information generated by the second identification information generator; and
a ticket issuing unit that issues a ticket corresponding to the presented identification information in a case in which a determination result by the determiner is affirmative.

5. The ticket issuing system according to claim 4, wherein the same seed value is set for the specific item in the first and second identification information generators.

6. The ticket issuing system according to claim 4, wherein the determiner outputs an affirmative determination result in a case in which the identification information presented from the terminal is identification information generated by the second identification information generator and in which the ticket corresponding to the presented identification information has not been issued yet.

7. A ticket issuing system comprising:
the game server device according to claim 1; and
a shop device connected to the game server device via a network;
the shop device comprising:
a determiner that determines whether or not identification information presented from the terminal is identification information generated by the first identification information generator and is shared with the game server device; and
a ticket issuing unit that issues a ticket corresponding to the presented identification information in a case in which a determination result by the determiner is affirmative.

8. The ticket issuing system according to claim 7, wherein the determiner outputs an affirmative determination result in a case in which the identification information presented from the terminal is shared identification information and in which the ticket corresponding to the presented identification information has not been issued yet.

9. A management method used in a ticket issuing system for issuing a ticket in correspondence with identification information or information based on the identification information, the method being performed in a game server device connected, via a network, to a terminal for providing a user with a game in which an item is acquired, comprising:
a step of generating identification information in accordance with a seed value assigned to a predetermined specific item; and
a step of transmitting, in association with the specific item, the identification information generated in accordance with the seed value of the specific item to a terminal of a user who has acquired the specific item.

10. A ticket issuing system comprising:
the game server device according to claim 2; and
a shop device,
the shop device comprising:
a second identification information generator that generates identification information by the same algorithm as an algorithm used by the first identification information generator;
a determiner that determines whether or not identification information presented from the terminal is identification information generated by the second identification information generator; and
a ticket issuing unit that issues a ticket corresponding to the presented identification information in a case in which a determination result by the determiner is affirmative.

11. The ticket issuing system according to claim 10, wherein the same seed value is set for the specific item in the first and second identification information generators.

12. The ticket issuing system according to claim 10, wherein the determiner outputs an affirmative determination result in a case in which the identification information presented from the terminal is identification information generated by the second identification information generator and in which the ticket corresponding to the presented identification information has not been issued yet.

13. A ticket issuing system comprising:
the game server device according to claim 3; and
a shop device,
the shop device comprising:
a second identification information generator that generates identification information by the same algorithm as an algorithm used by the first identification information generator;
a determiner that determines whether or not identification information presented from the terminal is identification information generated by the second identification information generator; and
a ticket issuing unit that issues a ticket corresponding to the presented identification information in a case in which a determination result by the determiner is affirmative.

14. The ticket issuing system according to claim 13, wherein the same seed value is set for the specific item in the first and second identification information generators.

15. The ticket issuing system according to claim 13, wherein the determiner outputs an affirmative determination result in a case in which the identification information presented from the terminal is identification information generated by the second identification information generator and in which the ticket corresponding to the presented identification information has not been issued yet.

16. A ticket issuing system comprising:
the game server device according to claim 2; and
a shop device connected to the game server device via a network;
the shop device comprising:
a determiner that determines whether or not identification information presented from the terminal is identification information generated by the first identification information generator and is shared with the game server device; and
a ticket issuing unit that issues a ticket corresponding to the presented identification information in a case in which a determination result by the determiner is affirmative.

17. The ticket issuing system according to claim 16, wherein the determiner outputs an affirmative determination result in a case in which the identification information presented from the terminal is shared identification information and in which the ticket corresponding to the presented identification information has not been issued yet.

18. A ticket issuing system comprising:
the game server device according to claim 3; and
a shop device connected to the game server device via a network;
the shop device comprising:
a determiner that determines whether or not identification information presented from the terminal is identification information generated by the first identification information generator and is shared with the game server device; and
a ticket issuing unit that issues a ticket corresponding to the presented identification information in a case in which a determination result by the determiner is affirmative.

19. The ticket issuing system according to claim 18, wherein the determiner outputs an affirmative determination result in a case in which the identification information presented from the terminal is shared identification information and in which the ticket corresponding to the presented identification information has not been issued yet.
